(19) United States
(12) Patent Application Publication
(10) Pub. No.: US 2016/0148513 A1
(43) Pub. Date: May 26, 2016

(54) METHOD AND APPARATUS FOR PROVIDING LINE-OF-SIGHT OBSTRUCTION NOTIFICATION FOR NAVIGATION

(71) Applicant: HERE Global B.V., Veldhoven (NL)

(72) Inventor: Jerome BEAUREPAIRE, Berlin (DE)

(21) Appl. No.: 14/548,764

(22) Filed: Nov. 20, 2014

(51) Int. Cl. G08G 1/16; G01C 21/34; G08G 1/0968

(52) U.S. Cl. CPC G08G 1/164; G08G 1/0968; G01C 21/3461; G08G 1/168

(57) ABSTRACT

An approach is provided for determining at least one alternate action to be performed by at least one first entity, at least one second entity, or a combination thereof for resolving at least one line-of-sight obstruction. The approach involves processing and/or facilitating a processing of sensor data to determine that at least one action by one or more first entities on at least one travel segment has a probability above a threshold value to result in the one or more first entities causing at least one line-of-sight obstruction for one or more second entities with respect to the at least one travel segment. The approach also involves determining one or more alternate actions to eliminate or to reduce the at least one line-of-sight obstruction, wherein the one or more alternate actions are to be performed by the one or more first entities, the one or more second entities, or a combination thereof. The approach further involves causing, at least in part, a presentation of the one or more alternate actions to at least one device associated with the one or more first entities, the one or more second entities, or a combination thereof.

### BACKGROUND

The number of accidents has been on the rise in spite of technological innovations and advancements for vehicle safety. It is desirable during vehicle maneuvers to be able to detect and notify line-of-sight obstructions for avoiding vehicle collisions. In view of the fact that an unobstructed line-of-sight is extremely important for the safety of road users (e.g., drivers, passengers, pedestrians etc.), service providers and device manufacturers (e.g., wireless, cellular, etc.) are continually challenged to deliver value and convenience to consumers by, for example, providing a method that prevents an entity (e.g., vehicles, moving objects etc.) from performing an action that obstructs the line-of-sight of other entity.

### Some Example Embodiments

Therefore, there is a need for an approach for determining at least one alternate action to be performed by at least one first entity, at least one second entity, or a combination thereof for resolving at least one line-of-sight obstruction.

According to one embodiment, a method comprises processing and/or facilitating a processing of sensor data to determine that at least one action by one or more first entities on at least one travel segment has a probability above a threshold value to result in the one or more first entities causing at least one line-of-sight obstruction for one or more second entities with respect to the at least one travel segment. The method also comprises determining one or more alternate actions to eliminate or to reduce the at least one line-of-sight obstruction, wherein the one or more alternate actions are to be performed by the one or more first entities, the one or more second entities, or a combination thereof. The method further comprises causing, at least in part, a presentation of the one or more alternate actions to at least one device associated with the one or more first entities, the one or more second entities, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of sensor data to determine that at least one action by one or more first entities on at least one travel segment has a probability above a threshold value to result in the one or more first entities causing at least one line-of-sight obstruction for one or more second entities with respect to the at least one travel segment. The apparatus is also caused to determine one or more alternate actions to eliminate or to reduce the at least one line-of-sight obstruction, wherein the one or more alternate actions are to be performed by the one or more first entities, the one or more second entities, or a combination thereof. The apparatus is further caused to cause, at least in part, a presentation of the one or more alternate actions to at least one device associated with the one or more first entities, the one or more second entities, or a combination thereof.

According to another embodiment, a computer-readable storage medium carries one or more sequences of one or more instructions which, when executed by one or more processors, cause, at least in part, an apparatus to process and/or facilitate a processing of sensor data to determine that at least one action by one or more first entities on at least one travel segment has a probability above a threshold value to result in the one or more first entities causing at least one line-of-sight obstruction for one or more second entities with respect to the at least one travel segment. The apparatus is also caused to determine one or more alternate actions to eliminate or to reduce the at least one line-of-sight obstruction, wherein the one or more alternate actions are to be performed by the one or more first entities, the one or more second entities, or a combination thereof. The apparatus is further caused to cause, at least in part, a presentation of the one or more alternate actions to at least one device associated with the one or more first entities, the one or more second entities, or a combination thereof.

According to another embodiment, an apparatus comprises means for processing and/or facilitating a processing of sensor data to determine that at least one action by one or more first entities on at least one travel segment has a probability above a threshold value to result in the one or more first entities causing at least one line-of-sight obstruction for one or more second entities with respect to the at least one travel segment. The apparatus also comprises means for determining one or more alternate actions to eliminate or to reduce the at least one line-of-sight obstruction, wherein the one or more alternate actions are to be performed by the one or more first entities, the one or more second entities, or a combination thereof. The apparatus further comprises means for causing, at least in part, a presentation of the one or more alternate actions to at least one device associated with the one or more first entities, the one or more second entities, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of determining at least one alternate action to be performed by at least one first entity, at least one second entity, or a combination thereof for resolving at least one line-of-sight obstruction, according to one embodiment;

FIG. 1B is a diagram of the geographic database 111 of system 100, according to exemplary embodiments;

FIG. 2 is a diagram of the components of the notification platform 109, according to one embodiment;

FIG. 3 is a flowchart of a process for processing sensor data to determine a line-of-sight obstruction, and determining alternate actions to curtail the obstruction, according to one embodiment;

FIG. 4 is a flowchart of a process for determining line-of-sight obstructions based, at least in part, on dimension information for one or more vehicles and/or characteristics information for one or more parking spots, according to one embodiment;

FIG. 5 is a flowchart of a process for determining suitable positions and/or orientations for blocking vehicles and/or blocked vehicle, according to one embodiment;

FIG. 6 is a flowchart of a process for determining road features in a travel segment to avoid line-of-sight obstruction, according to one embodiment;

FIG. 7 is a diagram that represents a scenario wherein a driver of at least one large vehicle is timely notified of an obstruction to ensure safe turning by oncoming vehicles at intersections, according to one example embodiment;

FIG. 8 is a diagram that represents a scenario wherein plurality of parked vehicles causes an obstruction in the line-of-sight of at least one oncoming vehicle, according to one example embodiment;

FIG. 9 is a diagram that represents a scenario wherein at least one parked vehicle blocks the view of a pedestrian crossing the road for an oncoming vehicle, according to one example embodiment;

FIG. 10 is a diagram that represents a multilane scenario wherein at least one large vehicle in the middle lane blocks the line-of-sight for vehicles on the side lanes, according to one example embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal (e.g., handset) that can be used to implement an embodiment of the invention.

### DESCRIPTION OF SOME EMBODIMENTS

Examples of a method, apparatus, and computer program for determining at least one alternate action to be performed by at least one first entity, at least one second entity, or a combination thereof for resolving at least one line-of-sight obstruction are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

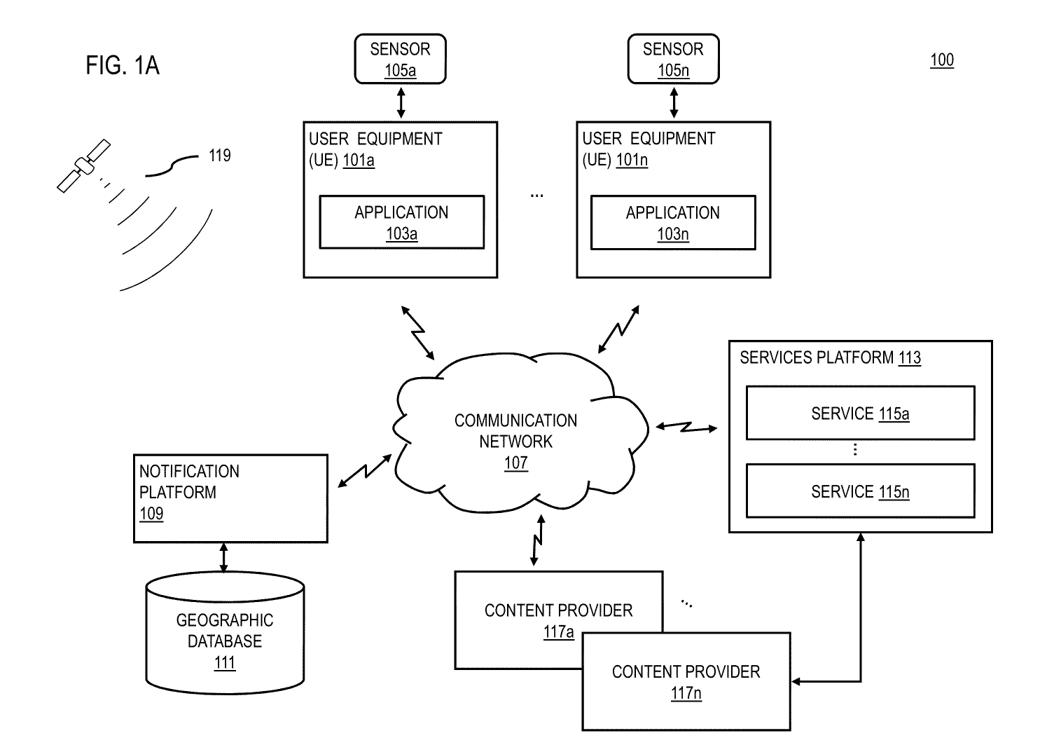

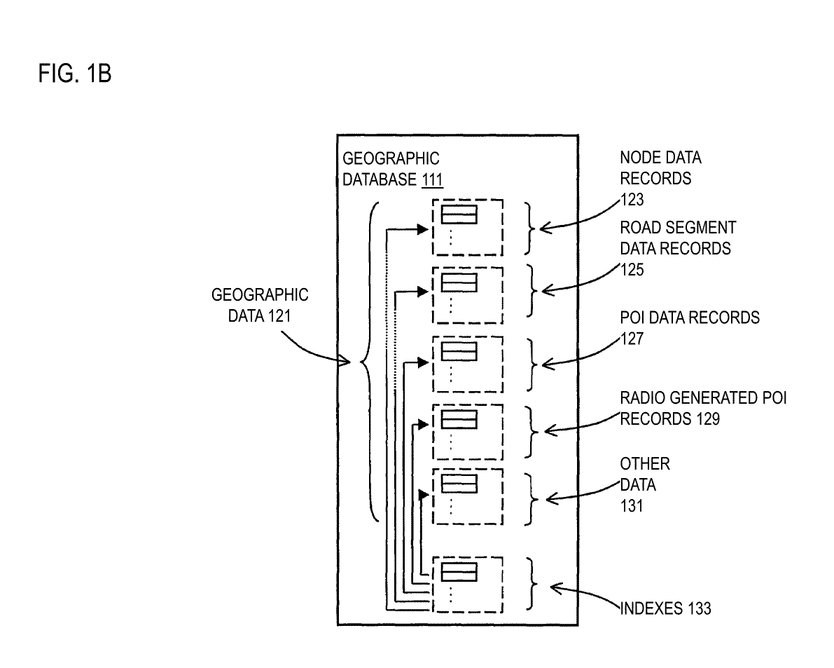

FIG. 1A is a diagram of a system capable of determining at least one alternate action to be performed by at least one first entity, at least one second entity, or a combination thereof for resolving at least one line-of-sight obstruction, according to one embodiment. As discussed, vehicular accidents may continue to increase if road safety is not adequately addressed. To avoid vehicular accidents, an increased use of assistance systems that detects an obstruction in a point-of-view, and timely (e.g., in real-time) notify oncoming vehicles may be implemented. In one scenario, a large vehicle parked nearby an intersection may block the line-of-sight for oncoming vehicles. In another scenario, a large vehicle in a driving lane may obstruct the line-of-sight for other nearby smaller vehicles (e.g., the large vehicle may block traffic lights, other smaller vehicles in another lane etc.). In a further scenario, a vehicle parked at a critical parking area (e.g., a parking area that is not suitable for any vehicles to be parked therein because any parked vehicle may obstruct the view for other oncoming vehicles) may block the view for oncoming vehicles. As a result, it is important to prevent an entity (e.g., parked vehicles, large vehicles, other moving objects) from blocking the view of other entities (e.g., oncoming vehicles) to prevent vehicular accidents.

To address this problem, a system 100 of FIG. 1 introduces the capability to detect obstructions and notify obstructing vehicles on activities they should avoid to prevent blocking of line-of-sight for passing vehicles. In one scenario, a truck driver parks at a parking area or is looking for a parking area on a specific location. The system 100 may check whether the parking area the truck is parked at or is about to park is a suitable parking area (i.e., parking in that area does not obstruct view on a specific location). If the parking area is determined to be a critical area (i.e., parking obstructs the view for oncoming vehicles), the truck driver is notified that he/she could be obstructing the views for oncoming vehicles and may suggest a new parking area. The system 100 combines mapping information, parking information, vehicle sensor information to improve driver's safety. In another scenario, the system 100 may notify one or more vehicles on the presence of an emergency vehicle in close proximity, and may recommend alternative action to avoid blocking the emergency vehicle. Since system 100 may perform real-time notification to one or more obstructing vehicles that their action is going to obstruct view for other vehicles and could endanger lives, it may incentivize obstructing vehicles to perform alternative actions to avoid the obstruction. In a further scenario, the system 100 may detect certain obstacles (e.g., road repairs, wrongly parked vehicles, bad street lighting condition etc.) in a road segment, and may notify vehicles travelling in the road segment on the possibility of line-of-sight obstructions.

As shown in FIG. 1A, the system 100 comprises user equipment (UE) 101a-101n (collectively referred to as UE 101) that may include or be associated with the applications 103a-103n (collectively referred to as applications 103) and sensors 105a-105n (collectively referred to as sensors 105). In one embodiment, the UE 101 has connectivity to a notification platform 109 via the communication network 107. In one embodiment, the notification platform 109 performs one or more functions associated with determining at least one alternate action to be performed by at least one first entity, at least one second entity, or a combination thereof for resolving at least one line-of-sight obstruction.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). In one embodiment, the UE 101 may be a vehicle (e.g., cars), a mobile device (e.g., phone), and/or a combination of the two.

By way of example, the applications 103 may be any type of application that is executable at the UE 101, such as location-based service applications, navigation applications, mapping application (e.g., parking spaces may be marked not suitable directly on the map to give direct feedback to drivers), content provisioning services, camera/imaging application, media player applications, social networking applications, calendar applications, and the like. In one embodiment, one of the applications 103 at the UE 101 may act as a client for the notification platform 109 and perform one or more functions associated with the functions of the notification platform 109 by interacting with the notification platform 109 over the communication network 107. In one scenario, the applications 103 may be an application for determining at least one alternate action to be performed by at least one first entity, at least one second entity, or a combination thereof for resolving at least one line-of-sight obstruction.

By way of example, the sensors 105 may be any type of sensor. In certain embodiments, the sensors 105 may include, for example, a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture obstruction for analysis and documentation purposes), an audio recorder for gathering audio data, and the like. In another embodiment, the sensors 105 may include light sensors, oriental sensors augmented with height sensor and acceleration sensor, tilt sensors to detect the degree of incline or decline of the vehicle along a path of travel, moisture sensors, pressure sensors, etc. In a further example embodiment, sensors about the perimeter of the vehicle may detect the relative distance of the vehicle from sidewalks, parking areas, lane or roadways, the presence of other vehicles, pedestrians, traffic lights, potholes and any other objects, or a combination thereof. In one scenario, the sensors 105 may detect weather data, traffic information, or a combination thereof. In one example embodiment, the UE 101 may include GPS receivers to obtain geographic coordinates from satellites 119 for determining current location and time associated with the UE 101. In another example embodiment, the one or more sensors may provide in-vehicle navigation services, wherein one or more location based services may be provided to the at least one UE 101 associated with the at least one user of the vehicle and/or at least one other UE 101 associated with the at least one vehicle.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the notification platform 109 may be a platform with multiple interconnected components. The notification platform 109 may include multiple servers, intelligent networking devices, computing devices, components and corresponding software for determining at least one alternate action to be performed by at least one first entity, at least one second entity, or a combination thereof for resolving at least one line-of-sight obstruction. In addition, it is noted that the notification platform 109 may be a separate entity of the system 100, a part of the one or more services 115a-115n (collectively referred to as services 115) of the services platform 113, or included within the UE 101 (e.g., as part of the applications 103.

In one embodiment, the notification platform 109 may process and/or facilitate a processing of sensor data to determine that at least one action by one or more first entities on at least one travel segment has a probability above a threshold value to result in the one or more first entities causing at least one line-of-sight obstruction for one or more second entities with respect to the at least one travel segment. In one scenario, the one or more first entities, one or more second entities, or a combination thereof may include vehicles, moving objects (e.g., advertisement boards) etc. In another scenario, the notification platform 109 may determine at least one vehicle parking at an intersection thereby blocking the view for drivers of oncoming vehicles to turn safely at the intersection. Then, the notification platform 109 may alert blocked vehicle (e.g., oncoming vehicle) and/or the blocking vehicle (e.g., the parked vehicle) regarding the obstruction of proper views at an intersection.

In one embodiment, the notification platform 109 may determine one or more alternate actions to eliminate or to reduce the at least one line-of-sight obstruction, wherein the one or more alternate actions are to be performed by the one or more first entities, the one or more second entities, or a combination thereof. In one scenario, the notification platform 109 may determine movement instructions for one or more vehicles, alternate parking position for the obstructing vehicle, vehicle positioning for at least one parked vehicle, or a combination thereof to reduce the line-of-sight obstruction.

In one embodiment, the notification platform 109 may cause, at least in part, a presentation of the one or more alternate actions to at least one device associated with the one or more first entities, the one or more second entities, or a combination thereof. In one scenario, the notification platform 109 may notify the parked vehicle regarding the line-of-sight obstruction and may suggest an alternate parking location, a different parking position, or a combination thereof. In another scenario, the notification platform 109 may instruct one or more oncoming vehicles on maneuvering a vehicle (e.g., reduce their speed level, stop few meters before the intersection) based, at least in part, on the obstruction. In another scenario, the notification platform 109 may notify one or more parking vehicles on areas they should avoid in order not to obstruct proper views at intersections. In one example embodiment, when large vehicle are about to park at locations which are deemed to be critical for driving safety, those vehicles may be prompted messages like “Parking here will reduce visibility for drivers turning into street X, would you consider another parking space?.” Subsequently, the notification platform 109 may suggest a suitable parking space nearby.

In one embodiment, the geographic database 111 may store attributes for one or more parking areas (i.e., parking area designated critical area in terms of line-of-sight obstruction), attributes for one or more routing segments (e.g., information on one or more curves, intersections), vehicle dimension information, vehicle position information in at least one parking area, speed limit information in at least one road segment (e.g., driving lanes, intersection etc.), or a combination thereof. The information may be any multiple types of information that can provide means for aiding in the content provisioning and sharing process.

The services platform 113 may include any type of service. By way of example, the services platform 113 may include mapping services, navigation services, travel planning services, notification services, social networking services, content (e.g., audio, video, images, etc.) provisioning services, application services, storage services, contextual information determination services, location based services, information (e.g., weather, news, etc.) based services, etc. In one embodiment, the services platform 113 may interact with the UE 101, the notification platform 109 and the content provider 117 to supplement or aid in the processing of the content information.

By way of example, the services 115 may be an online service that reflects interests and/or activities of users. The services 115 allow users to share location information, activities information, contextual information, historical user information and interests within their individual networks, and provides for data portability. The services 115 may additionally assist in providing the notification platform 109 with information on travel plans of at least one user, speed information for at least one user, user profile information, and a variety of additional information.

The content providers 117a-117n (collectively referred to as content provider 117) may provide content to the UE 101, the notification platform 109, and the services 115 of the services platform 113. The content provided may be any type of content, such as textual content, audio content, video content, image content, etc. In one embodiment, the content provider 117 may provide content that may supplement content of the applications 103, the sensors 105, or a combination thereof. By way of example, the content provider 117 may provide content that may aid in the processing of determining at least one alternate action to be performed for resolving a line-of-sight obstruction. In one embodiment, the content provider 117 may also store content associated with the UE 101, the notification platform 109, and the services 115 of the services platform 113. In another embodiment, the content provider 117 may manage access to a central repository of data, and offer a consistent, standard interface to data, such as a repository of attributes for one or more parking areas, attributes for one or more routing segments, vehicle dimension information, vehicle position information in at least one parking area, speed limit information in at least one road segment, or a combination thereof. Any known or still developing methods, techniques or processes for determining at least one alternate for resolving at least one line-of-sight obstruction may be employed by the notification platform 109.

By way of example, the UE 101, the notification platform 109, the services platform 113, and the content provider 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 1B is a diagram of the geographic database 111 of system 100, according to exemplary embodiments. In the exemplary embodiments, POIs and map generated POIs data can be stored, associated with, and/or linked to the geographic database 111 or data thereof. In one embodiment, the geographic or map database 111 includes geographic data 121 used for (or configured to be compiled to be used for) mapping and/or navigation-related services, such as for personalized route determination, according to exemplary embodiments. For example, the geographic database 111 includes node data records 123, road segment or link data records 125, POI data records 127, radio generated POI records 129, and other data records 131, for example. More, fewer or different data records can be provided. In one embodiment, the other data records 131 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example.

In exemplary embodiments, the road segment data records 125 are links or segments representing roads, streets, parking areas, or paths, as can be used in the calculated route or recorded route information for determination of one or more personalized routes, according to exemplary embodiments. The node data records 123 are end points corresponding to the respective links or segments of the road segment data records 125. The road link data records 125 and the node data records 123 represent a road network, such as used by vehicles, cars, and/or other entities. Alternatively, the geographic database 111 can contain path segment and node data records or other data that represent pedestrian paths or areas in addition to or instead of the vehicle road record data, for example.

The road link and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, parking areas (attributes on which parking areas are critical) etc. The geographic database 111 can include data about the POIs and their respective locations in the POI data records 127. The geographic database 111 can also include data about places, such as cities, towns, or other communities, and other geographic features, such as bodies of water, mountain ranges, etc. Such place or feature data can be part of the POI data 127 or can be associated with POIs or POI data records 127 (such as a data point used for displaying or representing a position of a city). In addition, the geographic database 111 can include data from radio advertisements associated with the POI data records 127 and their respective locations in the radio generated POI records 129. By way of example, a street is determined from the user interaction with the UE 101 and the content information associated with the UE 101, according to the various embodiments described herein.

The geographic database 111 can be maintained by the content provider in association with the services platform 113 (e.g., a map developer). The map developer can collect geographic data to generate and enhance the geographic database 111. There can be different ways used by the map developer to collect data. These ways can include obtaining data from other sources, such as municipalities or respective geographic authorities (e.g., designated parking areas). In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database 111 or data in the master geographic database 111 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 111 can be a master geographic database, but in alternate embodiments, the geographic database 111 can represent a compiled navigation database that can be used in or with end user devices (e.g., UEs 101) to provided navigation-related functions. For example, the geographic database 111 can be used with the UE 101 to provide an end user with navigation features. In such a case, the geographic database 111 can be downloaded or stored on the UE 101, such as in the applications 103, or the UE 101 can access the geographic database 111 through a wireless or wired connection (such as via a server and/or the communication network 107), for example.

In one embodiment, the end user device or UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the navigation device UE 101 can be a cellular telephone. An end user can use the device UE 101 for navigation functions such as guidance and map display, for example, to travel in a route and/or position a vehicle with minimal possibility of line-of-sight obstructions.

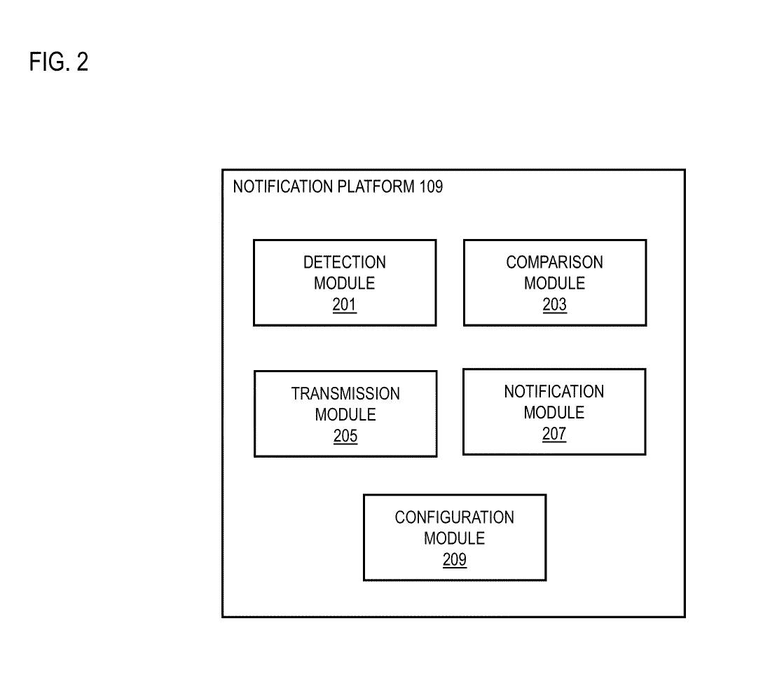

FIG. 2 is a diagram of the components of the notification platform 109, according to one embodiment. By way of example, the notification platform 109 includes one or more components for determining at least one alternate action to be performed by at least one first entity, at least one second entity, or a combination thereof for resolving at least one line-of-sight obstruction. It is contemplated that the functions of these components may be combined in one or more components or performed by other components of equivalent functionality. In this embodiment, the notification platform 109 includes a detection module 201, a comparison module 203, a transmission module 205, a notification module 207, and a configuration module 209.

In one embodiment, the detection module 201 may detect a line-of-sight obstruction by one or more first entities to the one or more second entities via the sensors 105. In another embodiment, the detection module 201 may detect a sensor-based-obstruction by one or more first entities to the one or more second entities via the sensors 105. In a further embodiment, the detection module may detect vehicle dimensions, vehicle movements, vehicle positions, or a combination thereof via the sensors 105.

In one embodiment, the comparison module 203 may evaluate the suitability of at least one parking area for one or more first entities (e.g., parked vehicles) by comparing the parking area with the dimensions of the one or more first entities. In another embodiment, the comparison module 203 may evaluate the appropriateness of one or more instructions (e.g., movement instructions) and/or one or more recommendations (e.g., recommendations on vehicle positioning, other suitable parking area, etc.) or a combination thereof.

In one embodiment, the transmission module 205 may cause a transmission of a query from the at least one first entity (e.g., a parked vehicle) to one or more second entities (e.g., oncoming vehicles) to determine if the parking area, the vehicle position, or a combination thereof causes line-of-sight obstruction to the one or more second entities. In another embodiment, the transmission module 205 may cause a transmission of one or more appropriate instructions, recommendations, or a combination thereof to the one or more first entities, one or more second entities, or a combination thereof.

In one embodiment, the notification module 207 may cause a presentation of at least one notification at at least one device associated with at least one first entity (e.g., obstructing vehicle), at least one second entity (e.g., obstructed vehicle), or a combination thereof to clear the obstruction. In one scenario, the notifications include movement instructions, recommendations on vehicle positioning, recommendations to other suitable parking areas, or a combination thereof. In another embodiment, the notification module 207 may cause notifications based, at least in part, on contextual information, wherein the contextual information include time-based information, traffic information, or a combination thereof. In one scenario, traffic at an intersection may be low at certain time of the day (e.g., early morning), then it might be okay for a vehicle to park nearby the intersection. However, parking at the intersection during peak hours may be discouraged. In one example embodiment, a notification based on contextual information may state “you may want to park at a particular location during certain time of the day.”

In one embodiment, the configuration module 209 may cause a configuration in a parking position, vehicle position, or a combination thereof in one or more first entities, one or more second entities, or a combination thereof based, at least in part, on a suitable line of sight. In one scenario, the comparison module 203 may compare vehicle types and dimensions with geometry of roads and intersections. The configuration module 209 may determine a “maximum recommended size” for a given parking space at a given intersection, and may not recommend any vehicles with dimensions more than the maximum recommended size to park on the parking area.

The above presented modules and components of the notification platform 109 can be implemented in hardware, firmware, software, or a combination thereof. Though depicted as a separate entity in FIG. 1A, it is contemplated that the notification platform 109 may be implemented for direct operation by respective UE 101. As such, the notification platform 109 may generate direct signal inputs by way of the operating system of the UE 101 for interacting with the applications 103. In another embodiment, one or more of the modules 201-209 may be implemented for operation by respective UEs, the notification platform 109, or combination thereof. Still further, the notification platform 109 may be integrated for direct operation with the services 115, such as in the form of a widget or applet, in accordance with an information and/or subscriber sharing arrangement. The various executions presented herein contemplate any and all arrangements and models.

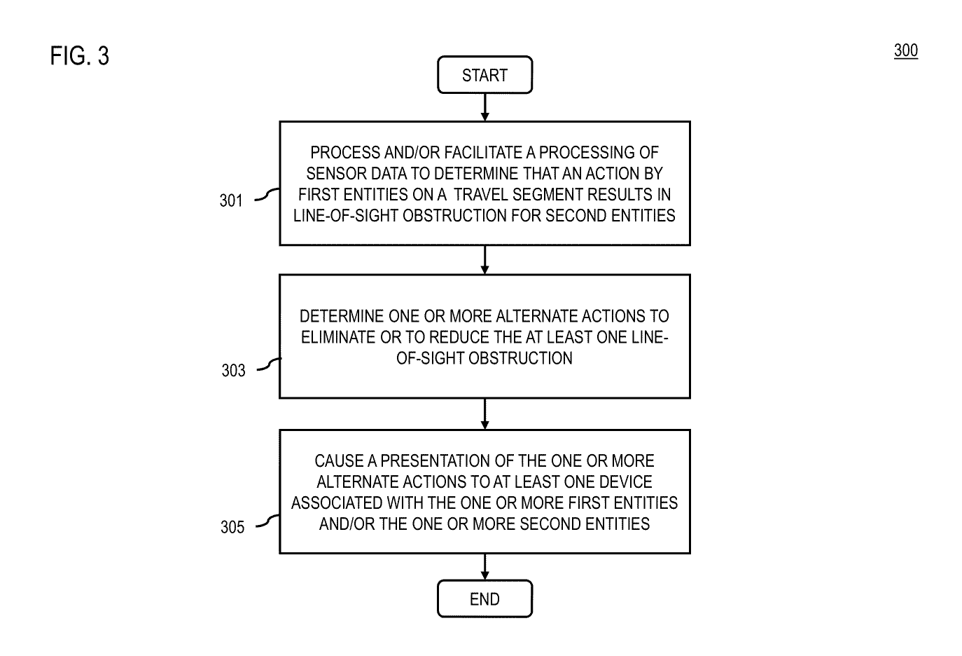

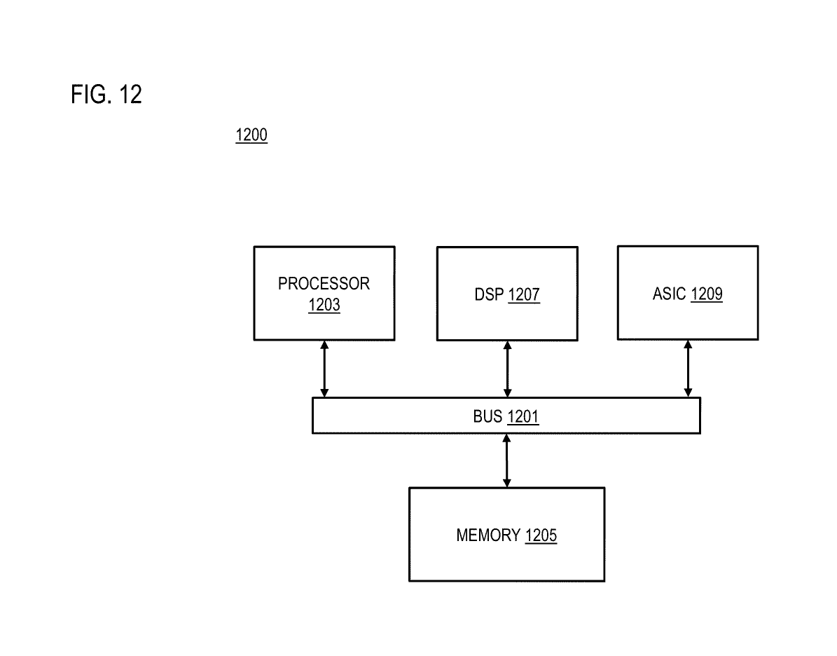

FIG. 3 is a flowchart of a process for processing sensor data to determine a line-of-sight obstruction, and determining alternate actions to curtail the obstruction, according to one embodiment. In one embodiment, the notification platform 109 performs the process 300 and is implemented in, for instance, a chip set including a processor and a memory as shown in FIG. 12.

In step 301, the notification platform 109 may process and/or facilitate a processing of sensor data to determine that at least one action by one or more first entities on at least one travel segment has a probability above a threshold value to result in the one or more first entities causing at least one line-of-sight obstruction for one or more second entities with respect to the at least one travel segment. In one scenario, the one or more first entities, the one or more second entities, or a combination thereof include one or more vehicles, one or more moving objects, structures, etc. In another scenario, the at least one travel segment includes at least one intersection, at least one junction, curvature of a road, and other road features. In a further scenario, the at least one action includes at least one parking action, at least one stopping action, or a combination thereof. In one example embodiment, the notification platform 109 may determine that a parking by a vehicle with dimensions greater than the maximum recommended size in a parking area may block the view for oncoming vehicles.

In step 303, the notification platform 109 may determine one or more alternate actions to eliminate or to reduce the at least one line-of-sight obstruction. The one or more alternate actions are to be performed by the one or more first entities, the one or more second entities, or a combination thereof. In one scenario, the one or more alternate actions includes parking in a different parking area, changing the position of the vehicle while parking, increasing or decreasing the speed of a vehicle, stopping few feet before the intersection or a crossing, and so on.

In step 305, the notification platform 109 may cause, at least in part, a presentation of the one or more alternate actions to at least one device associated with the one or more first entities, the one or more second entities, or a combination thereof. In one scenario, the notification platform 109 may detect an obstruction for at least one oncoming autonomous vehicle by at least one parked vehicle in an intersection. Then, the notification platform 109 may cause a presentation of a notification to the obstructing vehicle to clear the obstruction by performing an alternate action. Further, the notification platform 109 may notify the oncoming autonomous vehicles on the obstruction, and to stop at a point where there is more visibility. In another scenario, the notification may be dynamic based, at least in part, on sensor capabilities. In a further scenario, the notification may include alert messages on dangerous intersections, parking spots indicating only vehicles with certain dimensions may park, parking fees information (e.g., may include surcharge fee if vehicle with greater dimension is parked in the parking area), and so on.

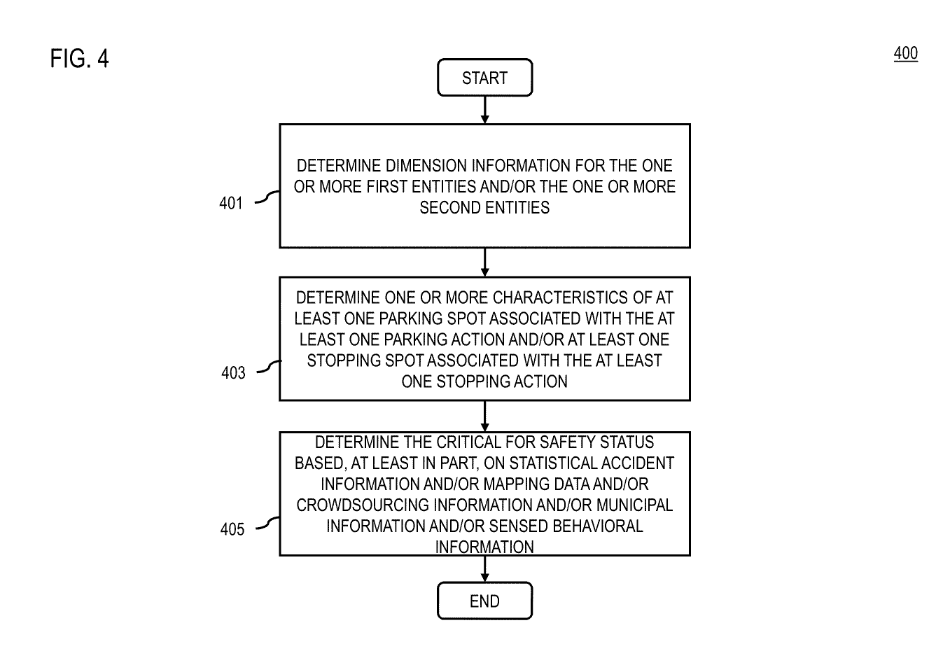

FIG. 4 is a flowchart of a process for determining line-of-sight obstructions based, at least in part, on dimension information for one or more vehicles and/or characteristics information for one or more parking spots, according to one embodiment. In one embodiment, the notification platform 109 performs the process 400 and is implemented in, for instance, a chip set including a processor and a memory as shown in FIG. 12.

In step 401, the notification platform 109 may determine dimension information for the one or more first entities, the one or more second entities, or a combination thereof. The probability of causing the at least one line-of-sight obstruction is further based, at least in part, on the dimension information. In one scenario, the notification platform 109 may detect dimension information for a vehicle and may notify the vehicle on line-of-sight obstructions. Then, the notification platform 109 may notify the vehicle an alternative action (e.g., another suitable parking area, recommended speed, etc.) based on the dimension information.

In step 403, the notification platform 109 may determine one or more characteristics of at least one parking spot associated with the at least one parking action, at least one stopping spot associated with the at least one stopping action, or a combination thereof. The probability of causing the at least one line-of-sight obstruction is further based, at least in part, on the one or more characteristics. In one embodiment, the one or more characteristics includes, at least in part, a designation as of the at least one parking spot, the at least one stopping spot, or a combination thereof with a critical for safety status. In one example embodiment, the notification platform 109 may detect characteristics for a parking area and/or a stopping area. Then, the notification platform 109 may notify an obstructing vehicle an alternative action (e.g., a suitable parking area, a stopping action, etc.) based on the characteristic information.

In step 405, the notification platform 109 may determine the critical for safety status based, at least in part, on statistical accident information (e.g., statistics about car accidents at intersections, types and causes of accidents), mapping data (e.g., data collected by map makers indicating attributes that an intersection is dangerous, city planners marking a parking spot indicating only vehicles with certain dimensions can park, parking fees information), crowdsourcing information, municipal information (e.g., government designated parking areas), sensed behavioral information (e.g., analyze user behavior), or a combination thereof. In one scenario, the crowdsourcing information may include users reporting location related information, for example, dangerous intersections, dangerous parking areas, etc. In such manners users may contribute to the open street mapping information. In one scenario, the notification platform 109 may detect behavioral data for one or more drivers, for example, gathering sensor based data of intersections at which users spend long time to turn (especially of those driver who turn slowly although there is no traffic on the crossing street). Further, the notification platform 109 may monitor behavior patterns of one or more drivers in the vehicle that may indicate difficulty in viewing well at intersections, for example, identifying through seat sensors that drivers are frantically moving their heads or bodies to see better.

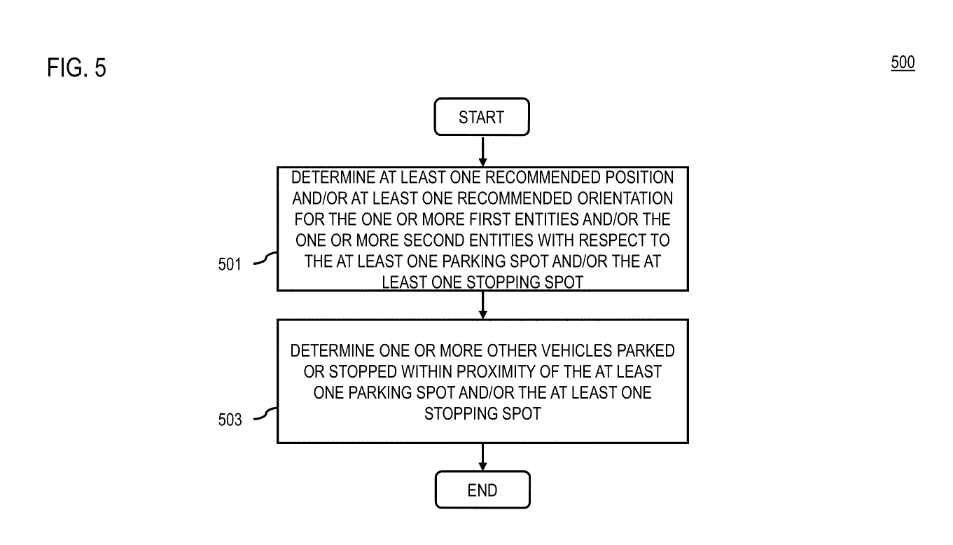

FIG. 5 is a flowchart of a process for determining suitable positions and/or orientations for blocking vehicles and/or blocked vehicle, according to one embodiment. In one embodiment, the notification platform 109 performs the process 500 and is implemented in, for instance, a chip set including a processor and a memory as shown in FIG. 12.

In step 501, the notification platform 109 may determine at least one recommended position, at least one recommended orientation, or a combination thereof for the one or more first entities, the one or more second entities, or a combination thereof with respect to the at least one parking spot, the at least one stopping spot, or a combination thereof to eliminate or to reduce the at least one line-of-sight obstruction. In one embodiment, the one or more alternate actions are based, at least in part, on the at least one recommended position, the at least one recommended orientation, or a combination thereof. In one example embodiment, a vehicle may be notified to park with its front facing the roadway. In another example embodiment, a large vehicle in a middle-lane may be notified to maintain a certain speed and position to ensure clear vision for smaller vehicles in the side-lanes (e.g., ensuring that a large moving vehicle does not block traffic lights for smaller vehicles).

In step 503, the notification platform 109 may determine one or more other vehicles parked or stopped within proximity of the at least one parking spot, the at least one stopping spot, or a combination thereof. The one or more alternate actions include, at least in part, switching a position of the one or more first entities, the one or more second entities, or a combination thereof with the one or more other vehicles. In one example embodiment, the notification platform 109 may cause a notification to at least one blocking vehicle (e.g., a large vehicle, a vehicle with objects on top, etc.) and/or at least one blocked vehicle (e.g., small vehicles) to swap positions in a safe manner to avoid line-of-sight obstruction. In another example embodiment, the notification platform 109 may notify the obstructing entity (e.g., any moving objects that blocks the view) to stop few meters away from the stopping spot to avoid line-of-sight obstruction.

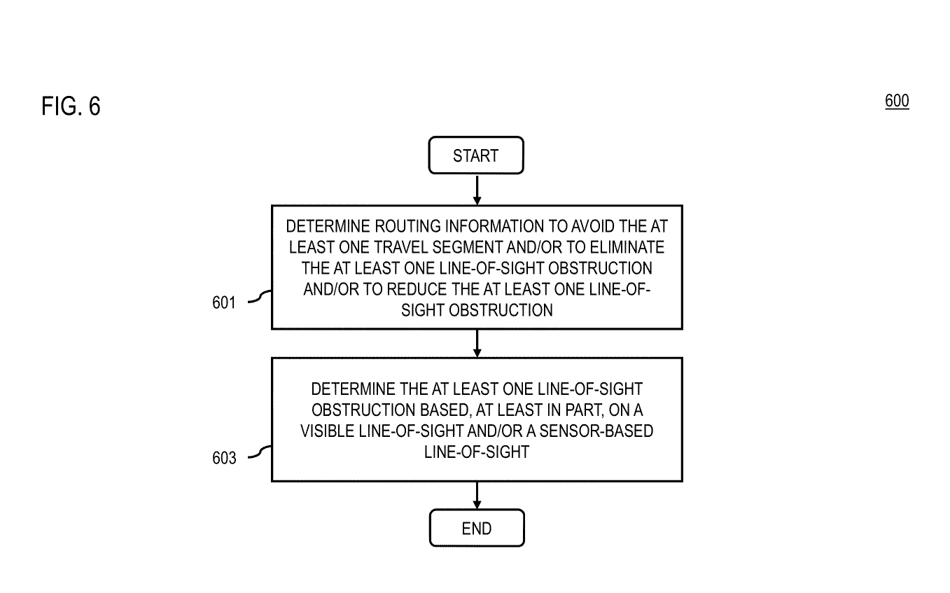

FIG. 6 is a flowchart of a process for determining road features in a travel segment to avoid line-of-sight obstruction, according to one embodiment. In one embodiment, the notification platform 109 performs the process 600 and is implemented in, for instance, a chip set including a processor and a memory as shown in FIG. 12.

In step 601, the notification platform 109 may determine routing information to avoid the at least one travel segment, to eliminate the at least one line-of-sight obstruction, to reduce the at least one line-of-sight obstruction, or a combination thereof. In one scenario, the notification platform 109 may determine road features for at least one routing segment, the dimensions for at least one oncoming vehicle travelling in the routing segment, or a combination thereof. Then, the notification platform 109 may cause a notification to the oncoming vehicle to avoid travelling in a particular road as it might create visibility issues because of the road features (e.g., a sharp curve, a narrow street, etc.).

In step 603, the notification platform 109 may determine the at least one line-of-sight obstruction based, at least in part, on a visible line-of-sight, a sensor-based line-of-sight, or a combination thereof. In one scenario, any blocking of sensors of at least one vehicle may be deemed an obstruction.

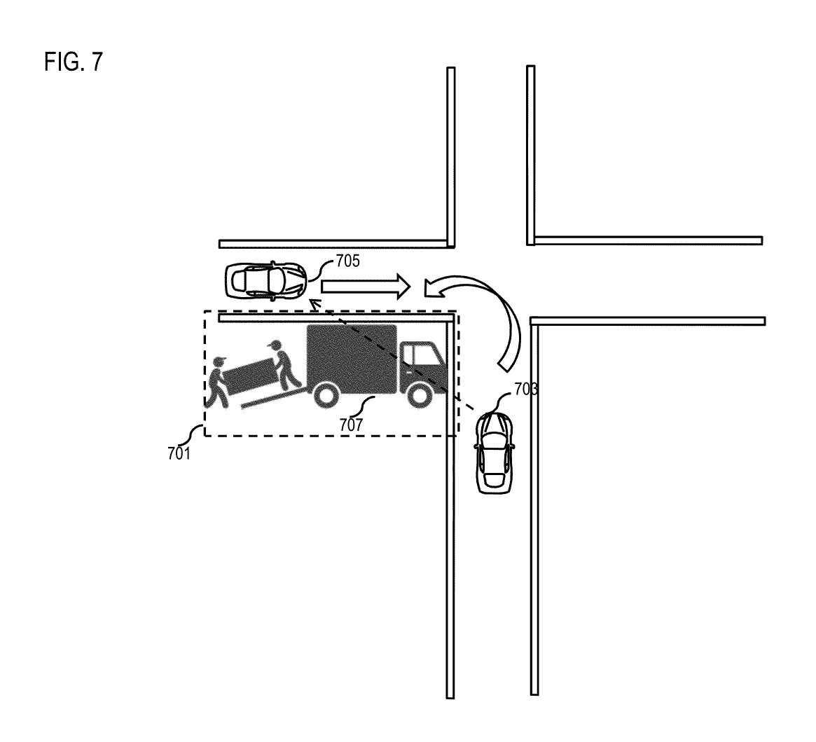

FIG. 7 is a diagram that represents a scenario wherein a driver of at least one large vehicle is timely notified of an obstruction to ensure safe turning by oncoming vehicles at intersections, according to one example embodiment. In one scenario, the notification platform 109 may determine at least one critical location 701 based, at least in part, on accident information, map information, crowdsourcing information, sensor information, or a combination thereof. The notification platform 109 may detect at least one large vehicle 707 parked or being parked at the critical location, thereby obstructing the line-of-sight for oncoming vehicles. The notification platform 109 may further detect that oncoming vehicle 703 is about to turn left and cannot see vehicle 705 coming from left. Such obstruction increases the likelihood for vehicle collision. As a result, the notification platform 109 may notify the driver of the large vehicle and/or the large vehicle (e.g., an autonomous vehicle) about the obstruction. The notification may include instructions to the driver of the large vehicle and/or the large vehicle to relocate to a suitable parking location.

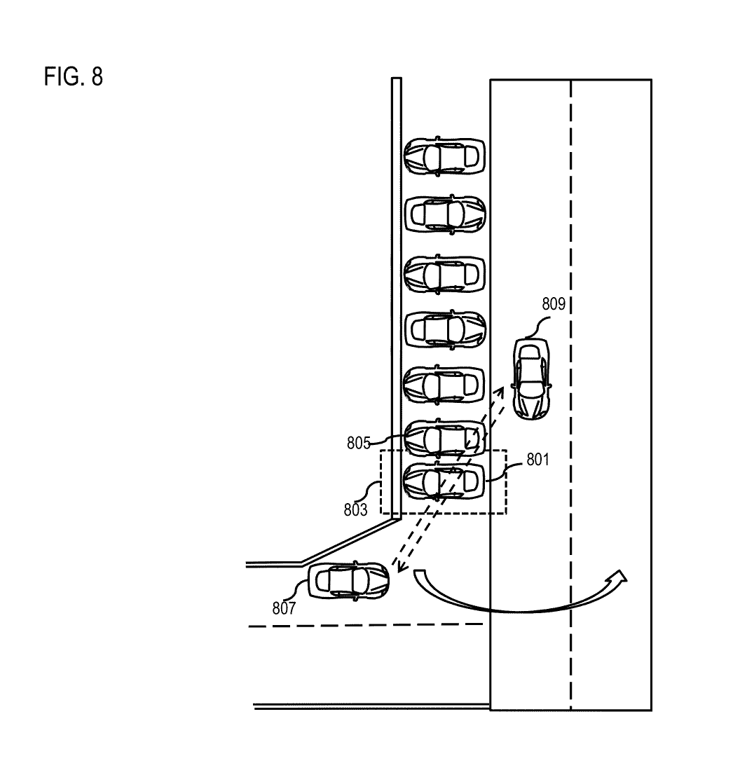

FIG. 8 is a diagram that represents a scenario wherein plurality of parked vehicles causes an obstruction in the line-of-sight of at least one oncoming vehicle, according to one example embodiment. In one scenario, the notification platform 109 may determine at least one vehicle 801 parked at a critical location 803. The notification platform 109 may determine the vehicle type and dimensions to trigger the notifications. Further, the notification platform 109 may group plurality of parked vehicles to determine an obstruction. In one example embodiment, the notification platform 109 may group vehicle 801 and vehicle 805 together, and may view them as one large vehicle that obstructs the line-of-sight for oncoming vehicle 807 and vehicle 809. Subsequently, the notification platform 109 may notify parked vehicles 803 and vehicle 805 to either move to another suitable location or change their vehicle position. In one scenario, the notification platform 109 may determine that if vehicles 803 and vehicle 805 adjusts their parking position (e.g., front of the vehicles facing the driving lane) the obstruction issue can be resolved.

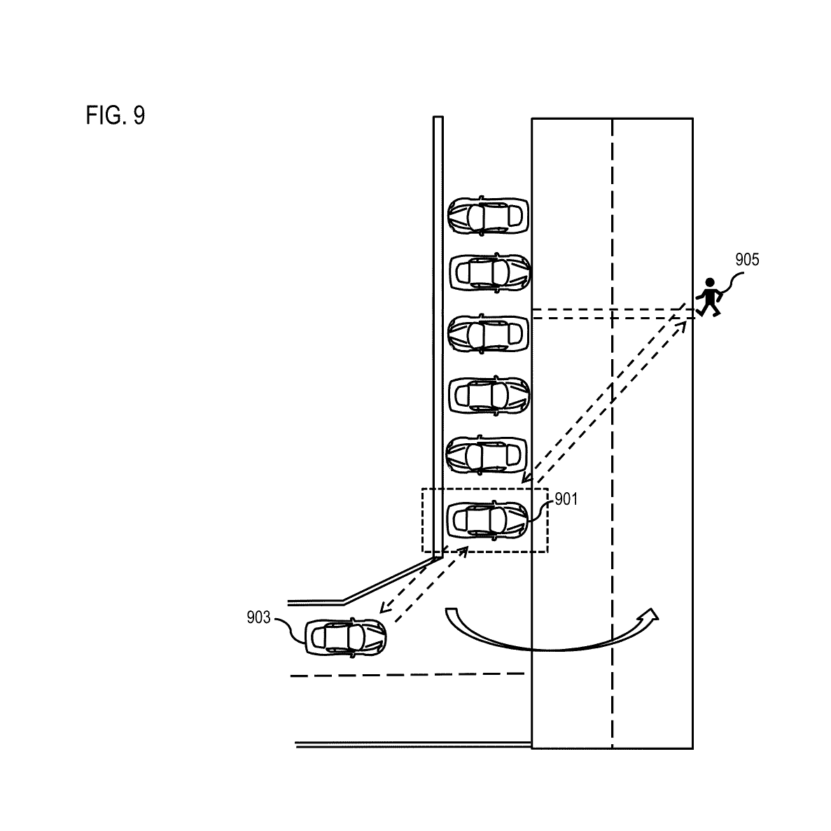

FIG. 9 is a diagram that represents a scenario wherein at least one parked vehicle blocks the view of a pedestrian crossing the road for an oncoming vehicle, according to one example embodiment. In one scenario, the notification platform 109 may detect at least one parked vehicle 901 obstructing the view for an oncoming vehicle 903 with regards to a pedestrian 905 crossing a road. Subsequently, the notification platform 109 may notify the parked vehicle 901 to move to another suitable parking area or cause an adjustment in the parking position. The notification platform 109 may also alert the oncoming vehicle 903 on the pedestrian situation (e.g., a notification that a nearby pedestrian is experiencing limited visibility), and the pedestrian 905 (e.g., a notification on UE 101 associated with the pedestrian on limited visibility for oncoming vehicle 903).

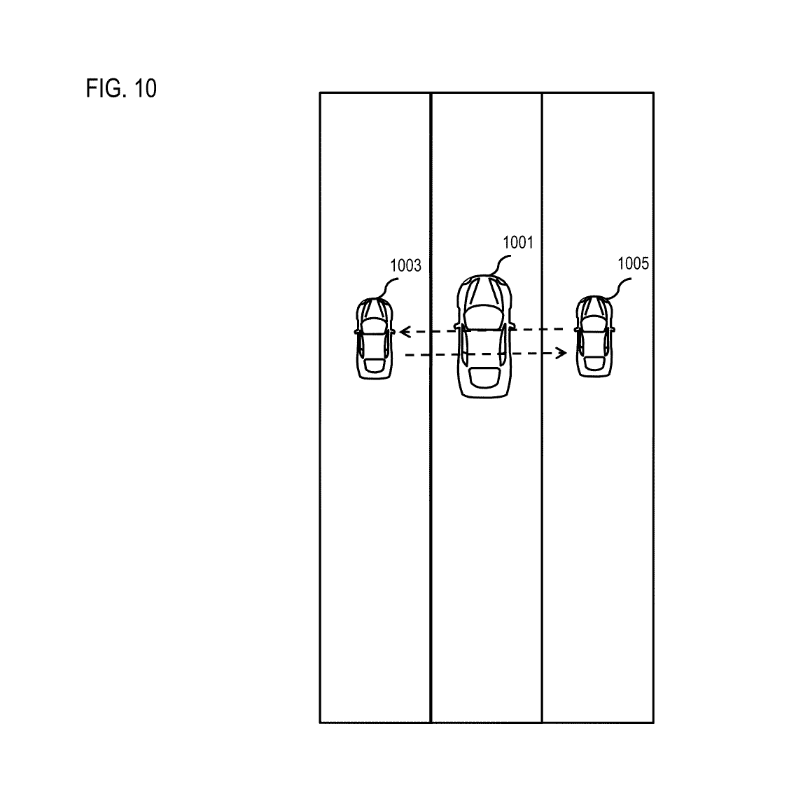

FIG. 10 is a diagram that represents a multilane scenario wherein at least one large vehicle in the middle lane blocks the line-of-sight for vehicles on the side lanes, according to one example embodiment. In one scenario, the notification platform 109 may detect a large vehicle 1001 (e.g., a truck) in the middle lane obstructing the views for smaller vehicles 1003 and 1005 on the side lanes. Subsequently, the notification platform 109 may cause a notification to the large vehicle 1001, for example, to maintain a certain speed level to avoid the blocking of the views for the small vehicles on the side lanes, or to stop few meters before the intersections to avoid blocking of the views for smaller vehicles. etc.

The processes described herein for determining at least one alternate action to be performed by at least one first entity, at least one second entity, or a combination thereof for resolving at least one line-of-sight obstruction may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

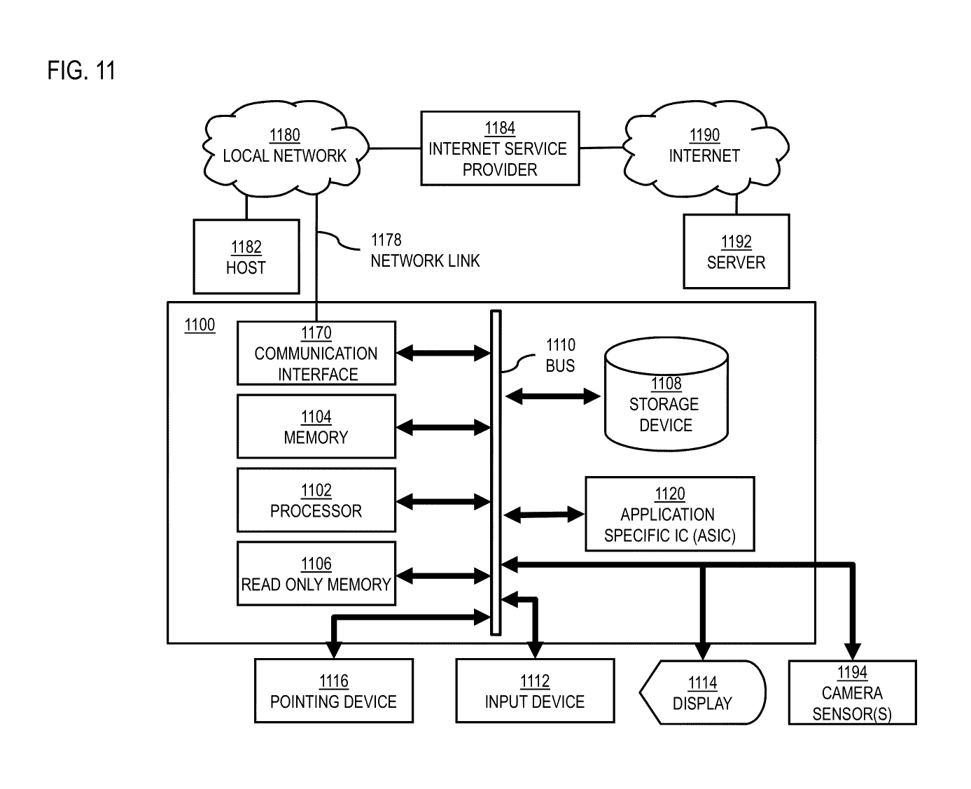

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to determine at least one alternate action to be performed by at least one first entity, at least one second entity, or a combination thereof for resolving at least one line-of-sight obstruction as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of determining at least one alternate action to be performed by at least one first entity, at least one second entity, or a combination thereof for resolving at least one line-of-sight obstruction.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to determine at least one alternate action to be performed by at least one first entity, at least one second entity, or a combination thereof for resolving at least one line-of-sight obstruction. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1100 also includes a memory 1104 coupled to bus 1110. The memory 1104, such as a random access memory (RAM) or any other dynamic storage device, stores information including processor instructions for determining at least one alternate action to be performed by at least one first entity, at least one second entity, or a combination thereof for resolving at least one line-of-sight obstruction. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or any other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for determining at least one alternate action to be performed by at least one first entity, at least one second entity, or a combination thereof for resolving at least one line-of-sight obstruction, is provided to the bus 1110 for use by the processor from an external input device 1112, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT), a liquid crystal display (LCD), a light emitting diode (LED) display, an organic LED (OLED) display, a plasma screen, or a printer for presenting text or images, and a pointing device 1116, such as a mouse, a trackball, cursor direction keys, or a motion sensor, for controlling a position of a small cursor image presented on the display 1114 and issuing commands associated with graphical elements presented on the display 1114, and one or more camera sensors 1194 for capturing, recording and causing to store one or more still and/or moving images (e.g., videos, movies, etc.) which also may comprise audio recordings. In some embodiments, for example, in embodiments in which the computer system 1100 performs all functions automatically without human input, one or more of external input device 1112, display device 1114 and pointing device 1116 may be omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of ASICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 107 for determining at least one alternate action to be performed by at least one first entity, at least one second entity, or a combination thereof for resolving at least one line-of-sight obstruction to the UE 101.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or any other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set or chip 1200 upon which an embodiment of the invention may be implemented. Chip set 1200 is programmed to determine at least one alternate action to be performed by at least one first entity, at least one second entity, or a combination thereof for resolving at least one line-of-sight obstruction as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of functions. Chip set or chip 1200, or a portion thereof, constitutes a means for performing one or more steps of determining at least one alternate action to be performed by at least one first entity, at least one second entity, or a combination thereof for resolving at least one line-of-sight obstruction.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to determine at least one alternate action to be performed by at least one first entity, at least one second entity, or a combination thereof for resolving at least one line-of-sight obstruction. The memory 1205 also stores the data associated with or generated by the execution of the inventive steps.

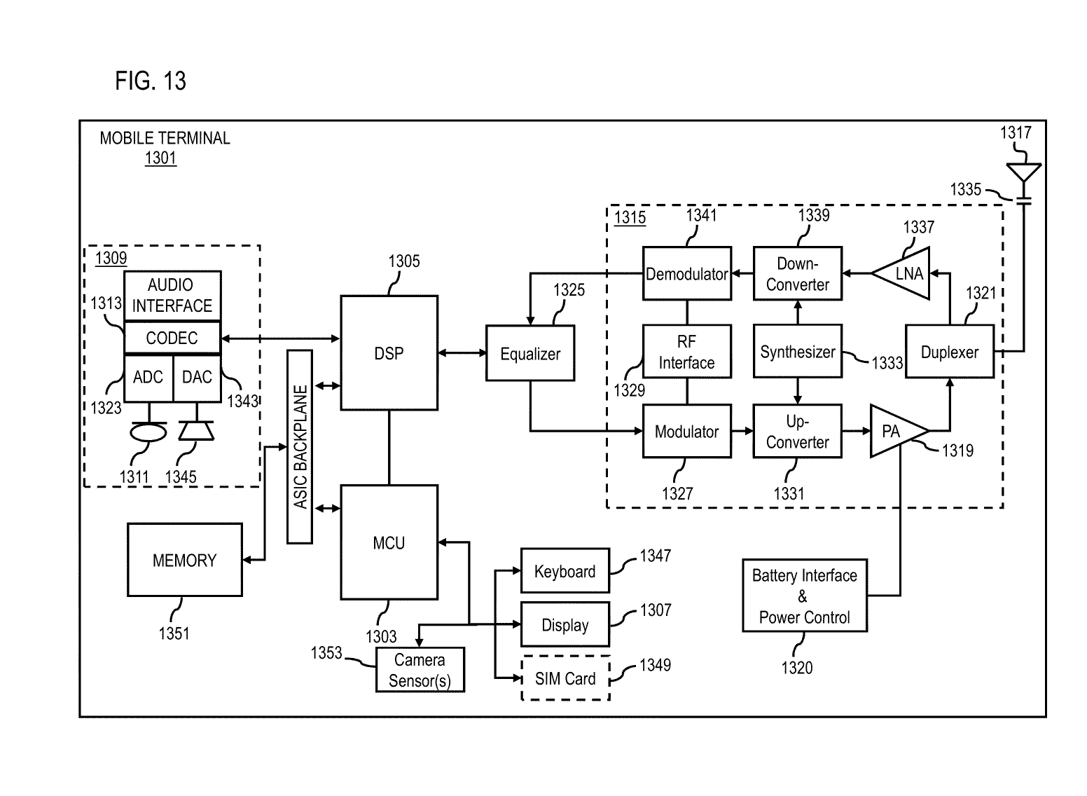

FIG. 13 is a diagram of exemplary components of a mobile terminal (e.g., handset) for communications, which is capable of operating in the system of FIG. 1, according to one embodiment. In some embodiments, mobile terminal 1301, or a portion thereof, constitutes a means for performing one or more steps of determining at least one alternate action to be performed by at least one first entity, at least one second entity, or a combination thereof for resolving at least one line-of-sight obstruction. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile terminal functions that perform or support the steps of determining at least one alternate action to be performed by at least one first entity, at least one second entity, or a combination thereof for resolving at least one line-of-sight obstruction. The display 1307 includes display circuitry configured to display at least a portion of a user interface of the mobile terminal (e.g., mobile telephone). Additionally, the display 1307 and display circuitry are configured to facilitate user control of at least some functions of the mobile terminal. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303 which can be implemented as a Central Processing Unit (CPU).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile terminal 1301 to determine at least one alternate action to be performed by at least one first entity, at least one second entity, or a combination thereof for resolving at least one line-of-sight obstruction. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the terminal. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile terminal settings.

Further, one or more camera sensors 1353 may be incorporated onto the mobile station 1301 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
processing and/or facilitating a processing of sensor data to determine that at least one action by one or more first entities on at least one travel segment has a probability above a threshold value to result in the one or more first entities causing at least one line-of-sight obstruction for one or more second entities with respect to the at least one travel segment;
determining one or more alternate actions to eliminate or to reduce the at least one line-of-sight obstruction, wherein the one or more alternate actions are to be performed by the one or more first entities, the one or more second entities, or a combination thereof; and
causing, at least in part, a presentation of the one or more alternate actions to at least one device associated with the one or more first entities, the one or more second entities, or a combination thereof.

2. A method of claim 1, further comprising:
determining dimension information for the one or more first entities, the one or more second entities, or a combination thereof,
wherein the probability of causing the at least one line-of-sight obstruction is further based, at least in part, on the dimension information.

3. A method of claim 1, wherein the one or more first entities, the one or more second entities, or a combination thereof include one or more vehicles; wherein the at least one travel segment includes at least one intersection, at least one junction, or a combination thereof; and wherein the at least one action includes at least one parking action, at least one stopping action, or a combination thereof.

4. A method of claim 3, further comprising:
determining one or more characteristics of at least one parking spot associated with the at least one parking action, at least one stopping spot associated with the at least one stopping action, or a combination thereof,
wherein the probability of causing the at least one line-of-sight obstruction is further based, at least in part, on the one or more characteristics.

5. A method of claim 4, wherein the one or more characteristics includes, at least in part, a designation as of the at least one parking spot, the at least one stopping spot, or a combination thereof with a critical for safety status.

6. A method of claim 5, further comprising:
determining the critical for safety status based, at least in part, on statistical accident information, mapping data, crowdsourcing information, municipal information, sensed behavioral information, or a combination thereof.

7. A method of claim 4, further comprising:
determining at least one recommended position, at least one recommended orientation, or a combination thereof for the one or more first entities, the one or more second entities, or a combination thereof with respect to the at least one parking spot, the at least one stopping spot, or a combination thereof to eliminate or to reduce the at least one line-of-sight obstruction,
wherein the one or more alternate actions are based, at least in part, on the at least one recommended position, the at least one recommended orientation, or a combination thereof.

8. A method of claim 4, further comprising:
determining one or more other vehicles parked or stopped within proximity of the at least one parking spot, the at least one stopping spot, or a combination thereof,
wherein the one or more alternate actions include, at least in part, switching a position of the one or more first entities, the one or more second entities, or a combination thereof with the one or more other vehicles.

9. A method of claim 1, further comprising:
determining routing information to avoid the at least one travel segment, to eliminate the at least one line-of-sight obstruction, to reduce the at least one line-of-sight obstruction, or a combination thereof.

10. A method of claim 1, further comprising:
determining the at least one line-of-sight obstruction based, at least in part, on a visible line-of-sight, a sensor-based line-of-sight, or a combination thereof.

11. An apparatus comprising:
at least one processor; and
at least one memory including computer program code for one or more programs, the at least one memory and the computer program code configured to, with the at least one processor, cause the apparatus to perform at least the following,
process and/or facilitate a processing of sensor data to determine that at least one action by one or more first entities on at least one travel segment has a probability above a threshold value to result in the one or more first entities causing at least one line-of-sight obstruction for one or more second entities with respect to the at least one travel segment;
determine one or more alternate actions to eliminate or to reduce the at least one line-of-sight obstruction, wherein the one or more alternate actions are to be performed by the one or more first entities, the one or more second entities, or a combination thereof; and
cause, at least in part, a presentation of the one or more alternate actions to at least one device associated with the one or more first entities, the one or more second entities, or a combination thereof.

12. An apparatus of claim 11, wherein the apparatus is further caused to:
determine dimension information for the one or more first entities, the one or more second entities, or a combination thereof,
wherein the probability of causing the at least one line-of-sight obstruction is further based, at least in part, on the dimension information.

13. An apparatus of claim 11, wherein the one or more first entities, the one or more second entities, or a combination thereof include one or more vehicles; wherein the at least one travel segment includes at least one intersection, at least one junction, or a combination thereof; and wherein the at least one action includes at least one parking action, at least one stopping action, or a combination thereof.

14. An apparatus of claim 13, wherein the apparatus is further caused to:
determine one or more characteristics of at least one parking spot associated with the at least one parking action, at least one stopping spot associated with the at least one stopping action, or a combination thereof,
wherein the probability of causing the at least one line-of-sight obstruction is further based, at least in part, on the one or more characteristics.

15. An apparatus of claim 14, wherein the one or more characteristics includes, at least in part, a designation as of the at least one parking spot, the at least one stopping spot, or a combination thereof with a critical for safety status.

16. An apparatus of claim 15, wherein the apparatus is further caused to:
determine the critical for safety status based, at least in part, on statistical accident information, mapping data, crowdsourcing information, municipal information, sensed behavioral information, or a combination thereof.

17. An apparatus of claim 14, wherein the apparatus is further caused to:
determine at least one recommended position, at least one recommended orientation, or a combination thereof for the one or more first entities, the one or more second entities, or a combination thereof with respect to the at least one parking spot, the at least one stopping spot, or a combination thereof to eliminate or to reduce the at least one line-of-sight obstruction,
wherein the one or more alternate actions are based, at least in part, on the at least one recommended position, the at least one recommended orientation, or a combination thereof.

18. A computer-readable storage medium carrying one or more sequences of one or more instructions which, when executed by one or more processors, cause an apparatus to at least perform the following steps:
process and/or facilitate a processing of sensor data to determine that at least one action by one or more first entities on at least one travel segment has a probability above a threshold value to result in the one or more first entities causing at least one line-of-sight obstruction for one or more second entities with respect to the at least one travel segment;
determine one or more alternate actions to eliminate or to reduce the at least one line-of-sight obstruction, wherein the one or more alternate actions are to be performed by the one or more first entities, the one or more second entities, or a combination thereof and cause, at least in part, a presentation of the one or more alternate actions to at least one device associated with the one or more first entities, the one or more second entities, or a combination thereof.

19. A computer-readable storage medium of claim 18, wherein the apparatus is further caused to:
determine dimension information for the one or more first entities, the one or more second entities, or a combination thereof,
wherein the probability of causing the at least one line-of-sight obstruction is further based, at least in part, on the dimension information.

20. A computer-readable storage medium of claim 18, wherein the one or more first entities, the one or more second entities, or a combination thereof include one or more vehicles; wherein the at least one travel segment includes at least one intersection, at least one junction, or a combination thereof and wherein the at least one action includes at least one parking action, at least one stopping action, or a combination thereof.

21-48. (canceled)
